(19) United States
(12) Patent Application Publication
(10) Pub. No.: US 2022/0281287 A1
(43) Pub. Date: Sep. 8, 2022

(54) VEHICLE SYSTEM

(71) Applicants: Ningbo Geely Automobile Research & Development Co., Ltd., Ningbo (CN); Zhejiang Geely Holding Group Co., Ltd., Zhejiang (CN)

(72) Inventors: Pardis SHARIATZADEH, Västra Frölunda (SE); Måns PIHLSGÅRD, Göteborg (SE); Magnus NILSSON, Floda (SE)

(21) Appl. No.: 17/825,933

(22) Filed: May 26, 2022

Related U.S. Application Data
(63) Continuation of application No. PCT/CN2020/133842, filed on Dec. 4, 2020.

(30) Foreign Application Priority Data
Dec. 6, 2019 (EP) 19214237.0

(51) Int. Cl. B60H 1/00; B60Q 3/20; B60R 7/04; B60Q 3/80

(52) U.S. Cl. CPC B60H 1/00735; B60Q 3/20; B60R 7/04; B60Q 3/80; B60H 1/00821

(57) ABSTRACT

A vehicle system includes a control unit, a vehicle compartment holding device for holding a removable accessory, and at least one vehicle compartment feature. The control unit is configured to receive a holding signal from the holding device, wherein the holding signal indicating if the holding device is holding the removable accessory or not, or if the holding device is in a first or second position. The control unit is further configured to send a control signal for changing a setting to the at least one vehicle compartment feature in response to a change in the holding signal, wherein the vehicle compartment feature is one of or any combination of compartment light, vanity mirror function, and compartment climate system.

### RELATED APPLICATION DATA

This application is a continuation of International Patent Application No. PCT/CN2020/133842, filed Dec. 4, 2020, which claims the benefit of European Patent Application No. 19214237.0, filed Dec. 6, 2019, the disclosures of which are incorporated herein by reference in their entireties.

### TECHNICAL FIELD

The present disclosure relates to a vehicle system comprising a control unit, a vehicle compartment holding device for holding a removable accessory, and at least one vehicle compartment feature. The disclosure further relates to a computer-implemented method for simplifying use of a removable accessory.

The vehicle system and method according to the disclosure can be arranged in a conventional vehicles configured to be steered by a user, as well as self-driving vehicles.

Moreover, even if the vehicle system according to the disclosure will be described primarily in relation to a car, the vehicle system is not restricted to this particular vehicle, but may as well be installed in another type of vehicle, such as a truck, a bus, a rail vehicle, a flying vehicle, a marine vessel, or the like.

### BACKGROUND

Vehicle systems including a removable accessory are known in the prior art. For example, document U.S. Pat. No. 5,884,008A shows a portable hair dryer for use in a vehicle, which portable hair dryer has a handle switch responsive to pivoting and vehicle battery voltage indicator.

However, there is a demand for providing simplified use of said removable accessory for a user located in the vehicle, for example during vehicle stillstand and/or vehicle travel.

### SUMMARY

An object of the present disclosure is to provide a vehicle system comprising a control unit, a vehicle compartment holding device for holding a removable accessory, and at least one vehicle compartment feature that provides simplified use of said removable accessory for a user located in the vehicle. This object is at least partly achieved by the features of the independent claims.

According to a first aspect of the present disclosure, there is provided a vehicle system comprising a control unit, a vehicle compartment holding device for holding a removable accessory, and at least one vehicle compartment feature, wherein the control unit is configured to receive a holding signal from the holding device. The holding signal indicating if the holding device is holding the removable accessory or not, or if the holding device is in a first or second position. The control unit is further configured to send a control signal for changing a setting to the at least one vehicle compartment feature in response to a change in the holding signal, wherein the vehicle compartment feature is one of or any combination of compartment light, vanity mirror function, and compartment climate system.

According to a second aspect of the present disclosure, there is provided a computer-implemented method for simplifying use of a removable accessory in a vehicle. The method comprises monitoring, by means of a vehicle control unit, a state of a holding device for holding the removable accessory, wherein a first state corresponds to when the holding device is holding the removable accessory and a second state corresponds to when the holding device is not holding the removable accessory, or wherein a first state corresponds to when the holding device is in a first position and a second state corresponds to when the holding device is in a second position. The method further comprising, when the state changes, changing a setting to at least one vehicle compartment feature by means of the vehicle control unit, wherein the at least one vehicle compartment feature is one of or any combination of compartment light, vanity mirror function, and compartment climate system.

In this way, the user may enjoy and benefit from automatic change of setting of the at least one vehicle compartment feature as soon as the user initiates use of the removable accessory. Thereby, the user does not need to also manually control the setting of the at least one vehicle compartment feature, which manual control may require good knowledge of the vehicle control interface and vehicle features, and additionally be inconvenient.

Further advantages are achieved by implementing one or several of the features of the dependent claims.

In some example embodiments, the vehicle system further comprises a removable accessory in form of a removable container including at least one vanity item, or in form of a removable vanity item. On other words, when a user desires to carry out some cosmetic, beauty or hair self-care, the user may simply remove the removable accessory from the holding device and gain access to a vanity item, and due to automatic change of setting of at least one of compartment light, vanity mirror function, and compartment climate system, the cosmetic, beauty or hair self-care is simplified.

In some example embodiments, the vanity item is a make-up item, a make-up remover item, a hair dryer, a shaving item, a hair styling tool, a nail polish item or nail polish remover.

In some example embodiments, the holding device is an openable and closeable storage compartment or an openable and closeable clamping device. Thereby, undesired displacement of the removable accessory, for example during driving, may be prevented. Moreover, the holding signal may relatively simply be arranged to indicate whether the holding device is in a first or second position, namely by monitoring whether the openable and closeable storage compartment or the openable and closeable clamping device is in a closed state or opened state.

According to some example embodiments, the compartment climate system includes at least one air vent configured for enabling ventilation air of the climate system to enter the passenger compartment, wherein the air vent is located in a vehicle dashboard, a vehicle A-pillar and/or a vehicle B-pillar. These positions are typically useful and efficient for directing warm or cold ventilation air towards an occupant or window for defrosting.

According to some example embodiments, the compartment climate system includes at least one air vent configured for enabling ventilation air of the climate system to enter the passenger compartment, wherein the air vent is adjustable in terms of flow direction and/or flow opening area for enabling the occupant to adjust direction and flow rate of incoming ventilation air the ventilation. Thereby, the ventilation flow may be individually adjusted to fit the specific occupant.

According to some example embodiments, the control unit is configured to monitoring a state of a holding device, wherein a first state corresponds to when the holding device is holding the removable accessory and a second state corresponds to when the holding device is not holding the removable accessory, or wherein a first state corresponds to when the holding device is in a closed state and a second state corresponds to when the holding device is in an open state, and wherein the control unit is configured to increase the intensity in compartment light when the state of the holding device goes from the first state to the second state and to decrease the intensity in compartment light when the state of the holding device goes from the second state to the first state. Thereby, illumination within the passenger compartment is increased when removing the removable accessory from the holding device, and oppositely.

The disclosure also relates to a vehicle comprising a system as described above.

In some example embodiments, the holding device is arranged at a seat of the vehicle, at an entrance door of the vehicle, at a passenger leg space of the vehicle, at a vehicle center console, at a vehicle dashboard, or at a vehicle interior roof. Common for these locations are easy access to the removable accessory, which is held by the holding device, by a user while being seated in a vehicle seat.

In some example embodiments, the step of changing the setting to the at least one vehicle compartment feature in response to a change in the holding signal involves moving a vanity mirror or electronic display that may be set in a selfie mode from a storage position to a display position, and wherein the vehicle comprises a recess in the roof for receiving the vanity mirror or electronic display when being positioned in the storage position. In other words, when the user removes the removable accessory from the holding device, the vanity mirror or electronic display that may carry out a mirror functionality, automatically moves from the storage position in a recess in the roof to a display position in front of the user for simplifying cosmetic, beauty or hair self-care.

In some example embodiments, the vehicle comprises a plurality of seats for vehicle passengers, and the control unit is configured to determining a seating location of a user removing a removable accessory from the holding device, and based on the determined seating location, changing the setting of the vehicle compartment feature. Thereby, the vehicle system may adapt the change of setting of the vehicle compartment feature specifically to the seat of the relevant user.

In other words, in a vehicle having at least a first seat and a second seat, each being associated with an individual holding device adapted for holding an individual removable accessory, a removal of the removable accessory from the holding device associated with the first seat will then result in a change of setting of the vehicle compartment feature specifically directed towards a user seated in the first seat, while only little or substantially no change of setting of the vehicle compartment feature will occur for the user seated in the second seat. For example, if the vehicle compartment feature is vanity mirror function, such as for example motion of a first vanity mirror from a storage position to a display position, the user seated in the first seat will be provided with a vanity mirror function, while the user seated in the second seat will not be provided with a vanity mirror function, i.e. a second vanity mirror will remain in the storage position.

In some example embodiments, the removable compartment accessory is a removable container with at least one vanity item, or a removable vanity item.

In some example embodiments, changing the setting to the at least one vehicle compartment feature involves the steps of increasing the intensity in compartment light by means of the vehicle control unit when the state of the holding device goes from the first state to the second state, and decreasing the intensity in compartment light by means of the vehicle control unit when the state of the holding device goes from the second state to the first state. Consequently, removal of the removable accessory from the holding device will result in increased compartment light intensity, and putting back the removable accessory to the holding device will result in decreased compartment light intensity.

In some example embodiments, changing the setting to at least one vehicle compartment feature involves increasing an intensity in vanity mirror light by means of the vehicle control unit when the state of the holding device goes from the first state to the second state, and decreasing the intensity in vanity mirror light by means of the vehicle control unit when the state of the holding device goes from the second state to the first state. Consequently, removal of the removable accessory from the holding device will result in increased vanity mirror light intensity, and putting back the removable accessory to the holding device will result in decreased vanity mirror light intensity.

In some example embodiments, changing the setting to at least one vehicle compartment feature involves initiating display of a vanity mirror, or initiating selfie mode of an electronic display, by means of the vehicle control unit when the state of the holding device goes from the first state to the second state, and terminating display of the vanity mirror, or terminating the selfie mode of the electronic display, by means of the vehicle control unit when the state of the holding device goes from the second state to the first state. Consequently, removal of the removable accessory from the holding device will result in provision of vanity mirror functionality, and putting back the removable accessory to the holding device will result in termination of the vanity mirror functionality.

In some example embodiments, the method further comprises further comprises steps of obtaining a vehicle operating state by means of the vehicle control unit and determining whether the current vehicle operating state is a safe state for changing the setting to the at least one vehicle compartment feature, or whether the current vehicle operating state is an unsafe state for changing the setting to the at least one vehicle compartment feature, and inhibiting any change of setting to the at least one vehicle compartment feature unless the current vehicle operating state is the safe state. Thereby, the vehicle system restrains a vehicle driver from for example cosmetic, beauty or hair self-care during driving for avoiding driver distraction from closely following the traffic situation.

In some example embodiments, the method further comprises wherein a safe state corresponds to a stationary vehicle or a vehicle operating in a self-driving mode.

Further features and advantages of the invention will become apparent when studying the appended claims and the following description. The skilled person in the art realizes that different features of the present disclosure may be combined to create embodiments other than those explicitly described hereinabove and below, without departing from the scope of the present disclosure.

### BRIEF DESCRIPTION OF THE DRAWINGS

The disclosure will be described in detail in the following, with reference to the attached drawings, in which

FIG. 1 shows schematically an interior view of a vehicle passenger compartment having an example embodiment of the vehicle system according to the disclosure,

FIG. 2 shows schematically a further interior view of a vehicle passenger compartment having another example embodiment of the vehicle system according to the disclosure,

FIG. 3 shows schematically still a further interior view of a vehicle passenger compartment having still another example embodiment of the vehicle system according to the disclosure,

FIG. 4 shows schematically a side of a vehicle having an example embodiment of the vehicle system according to the disclosure,

FIG. 5 shows schematically an example embodiment of the holding device and a removable accessory,

FIG. 6 shows schematically a further example embodiment of the holding device and a removable accessory,

FIG. 7 shows schematically still another example embodiment of the holding device and a removable accessory,

FIG. 8 shows schematically an example embodiment of the holding device and a removable accessory in form of a hair dryer,

FIGS. 9A and 9B show schematically an example embodiment of the holding device in form a storage compartment in a closed and opened state, respectively,

FIGS. 10A and 10B show schematically an example embodiment of the vehicle compartment feature in form of a vanity mirror function, in a storage position and display position, respectively,

FIGS. 11A-11C show schematically a sectional view of the vanity mirror function of FIGS. 10A-10B in three consecutive motion states,

FIG. 12 shows a first example embodiment of a flow chart describing the method according to the disclosure,

FIG. 13 shows a second example embodiment of a flow chart describing the method according to the disclosure, and

FIG. 14 shows a third example embodiment of a flow chart describing the method according to the disclosure.

### DETAILED DESCRIPTION

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

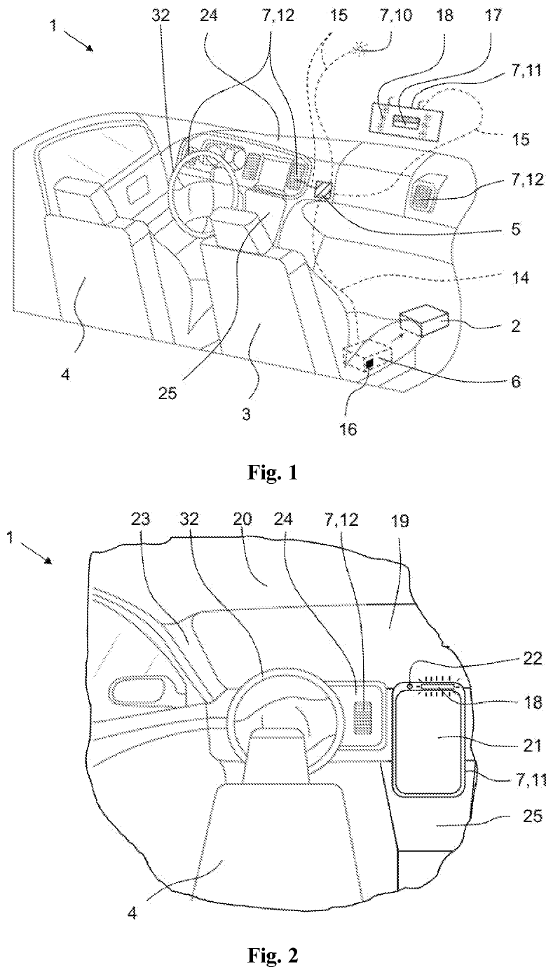

FIG. 1 schematically shows an interior of a passenger compartment of the vehicle, including a driver seat 4, a passenger seat 3, a steering wheel 32, a dashboard 24, etc. A first example embodiment of a vehicle system 1 according to the disclosure is described below with reference to FIG. 1. The vehicle system 1 is configured for providing simplified use of a removable accessory 2 for a user located in the vehicle. For example, the user may be seated in the passenger seat 3 side by side with the driver seat 4. Alternatively, the user may be seated in the driver seat 4, or in any of the rear seats, or any other seat of the vehicle.

The vehicle system 1 comprises a control unit 5, a vehicle compartment holding device 6 for holding the removable accessory 2, and at least one vehicle compartment feature 7. The control unit 5 is configured to receive a holding signal 14 from the holding device 6, the holding signal 14 indicating if the holding device 6 is holding the removable accessory 2 or not. The control unit 5 is further configured to send a control signal 15 for changing a setting to the at least one vehicle compartment feature 7 in response to a change in the holding signal 14, wherein the vehicle compartment feature 7 is one of or any combination of compartment light 10, vanity mirror function 11, and compartment climate system 12.

In other words, some kind of sensor or detector device 16 associated with the holding device 6 generates a holding signal 14 that enables the control unit 5 to determine whether the holding device 6 is holding the removable accessory 2, or whether the holding device 6 is not holding the removable accessory 2.

For example, the sensor or detector device 16 associated with the holding device 6 may be a proximity sensor, which for example rely on electromagnetic fields, light and/or sound for determining range to an object, thereby signaling the presence of a removable accessory in the holding device 6, or not. For example, the proximity sensor may be an ultrasonic sensor. According to still a further example, the removable accessory 2 may include a radio frequency (RF and RFID) tag and a transceiver arrangement at the holding device 6 may be configured for signaling the presence of a removable accessory in the holding device 6, or not.

Alternatively, the sensor or detector device 16 may be a contact sensor, such as a mechanical contact switch, or light barrier sensor, configured for being sensitive to the presence of the removable accessory 2 in the holding device 6.

Still more alternatively, the sensor or detector device 16 may be a vision sensor, such as a camera, wherein the sensor or detector device, or the control unit 5, or a cloud based processing unit, may be used for executing image recognition software configured determining the presence of the removable accessory 2 in the holding device 6.

The control unit 5 may be configured to monitor the holding signal 14, and to send a control signal 15 to the at least one vehicle compartment feature 7 for changing a setting thereof, in response to a change in the holding signal 14, in particular in response to detection of removal of the removable accessory 2 from the holding device 6.

The holding signal and/or control signal 15 may be transmitted via an electrically conductive wire or via wire-less technology.

In the example embodiment of FIG. 1, three different types of vehicle compartment features 7 are illustrated being controlled by the control unit 5, namely compartment light 10, vanity mirror function 11, and compartment climate system 12. However, the vehicle system according to the disclosure may alternatively be implemented such that the control unit controls only one of these three vehicle compartment features 7, based on the received holding signal 14. Hence, the control unit 5 may be configured to send a control signal 15 to compartment light 10 only, or vanity mirror function 11 only, or to the compartment climate system 12 only, for changing a setting thereof, in response to a change in the holding signal 14.

The term compartment light 10 means the lighting arrangement for lighting up the interior of the passenger compartment. The compartment light 10 may thus for example corresponds to one, two or more interior lights or light assemblies arranged for illuminating the interior of the compartment. The one or more lights or light assemblies may be point lights, i.e. forming a substantially rounded or rectangular light source, or elongated lights, i.e. strip like light sources. The compartment light 10 serve to illuminate the passenger compartment for enhancing a user's or passenger's interior compartment visibility. In particular, the compartment light 10 may be arranged to relatively strongly illuminate the user or passenger when seated in a vehicle seat 3, 4. The compartment light 10 does not mean light dedicated primarily for illuminating the interior of a small storage compartment, such as a glove-compartment or the like.

A change of setting of the compartment light 10 may thus involve a change in terms of illumination strength of the compartment light 10, e.g. a change in lumen or lux.

The term vanity mirror function may refer to various different aspects that influence and provide vanity mirror functionality for a use or passenger, i.e. vanity mirror provision. For example, vanity mirror function may correspond vanity mirror position in case of a moveable vanity mirror arrangement. The vanity mirror 17 may for example be movable between a storage position and a display position, wherein the vanity mirror 17 when located in the storage position is arranged to give the user or driver good driving and/or vehicle exterior visibility, and thus not to conceal or block exterior visibility.

Moreover, the vanity mirror 17 when located in the display position may be arranged to provide the user or driver with good self-visibility, in particular of the driver's or user's own face and/or hair. In other words, vanity mirror 17 may be arranged in front of the face of a driver or user when being located in the display mode.

The vanity mirror 17 may be configured to be moved, folded, pivoted or slid between the storage position and display position.

According to a further example, vanity mirror function may correspond to mirror visibility in case of a moveable mirror cover or mirror cover with adjustable transparency. The vanity mirror 17 may thus be stationary while the mirror cover position or mirror cover transparency may be adjustable for enabling a user selective access to a vanity mirror.

FIG. 2 schematically shows a further example of interior of a passenger compartment of the vehicle, including a driver seat 4, a steering wheel 32, a dashboard 24, a roof, a windscreen 19, etc.

According to a further example, as schematically illustrated in FIG. 2, the vanity mirror function may correspond to setting a vehicle electronic display 21 that may be set in a selfie mode. Selfie mode involves for example recording moving images using a camera 22 and displaying the recorded movie in real-time on the electronic display 21. The camera 22 may for example be integrated in the same unit as the electronic display 21, as shown in FIG. 2. Alternatively, the camera 22 may be mounted separately from the display 21. The electronic display 21 may for example be a stationary vehicle display, such as a dashboard-mounted display. Alternatively, the electronic display may be moveable between a storage position and a display position.

With reference to FIG. 1 and FIG. 2, the vanity mirror function may, according to still a further example, correspond to vanity mirror light 18, i.e. a dedicated light source 18 configured for illuminating a user that is located in front of the vanity mirror 17 or the electronic display 21. The vanity mirror light 18 may for example be positioned adjacent the vanity mirror 17 or electronic display 21, e.g. on the same unit as the vanity mirror 17 or electronic display 21. Alternatively, the vanity mirror light 18 may be located at a suitable location in the passenger compartment, such as for example in the interior roof 20, at any of the side pillars 23, at the dashboard 24, at the vehicle center console 25, or the like.

A change of setting of the vanity mirror function may thus for example involve movement of the vanity mirror between a storage position and a display position, or a change in mirror visibility in case of a moveable mirror cover or mirror cover with adjustable transparency, or setting the vehicle electronic display in a selfie mode, or a change in vanity mirror light intensity.

The term compartment climate system 12 corresponds for example to the vehicle HVAC system, i.e. heating, ventilation and air conditioning system arranged for providing indoor and automotive ambient comfort.

A change of setting of the compartment climate system 12 may thus for example involve a change in air temperature of the ventilation air entering the passenger compartment via air vents, or a change in air flow direction of the ventilation air entering the passenger compartment via air vents, or a change in air velocity (distance traveled per unit of time) or air volume flow (m3 per unit of time) of the ventilation air entering the passenger compartment via air vents.

Specifically, a change of setting of the compartment climate system 12 may for example involve temporary reducing air temperature of the ventilation air entering the passenger compartment via air vents in case the removable accessory is a hair dryer, for the purpose of proactively avoiding cabin temperature increase caused by operation of the hair dryer. Furthermore, a change of setting of the compartment climate system 12 may for example involve temporary increasing air velocity or air volume flow of the ventilation air entering the passenger compartment at an air vent that is located closest or adjacent to the seat of the user that removed the removable accessory from the holding device 6, thereby enabling improved drying of for example applied nail polish, or improved ventilation for more quickly diluting evaporated organic solvent of for example a nail polish remover.

The air vent for enabling ventilation air to enter the passenger compartment described above is for example located in a vehicle dashboard, a vehicle A-pillar or vehicle B-pillar. These locations are conventional locations for ventilation air vents in vehicles. Moreover, these types of vents are together with the compartment climate system 12 typically provided for accomplishing an agreeable temperature within the passenger compartment suitable for the occupants of the vehicle. In addition, these vents are often, but not strictly necessary, adjustable in terms of flow direction and/or flow opening area for enabling the occupant to adjust direction and flow rate of incoming ventilation air the ventilation.

According to a further example embodiment, the vehicle may comprise a plurality of seats 3, 4 for vehicle passengers, and the control unit 5 may be configured to determining a seating location of a user removing a removable accessory 2 from the holding device 6, and based on the determined seating location, changing the setting of the vehicle compartment feature 7, i.e. changing the setting of one or more vehicle compartment features 7 associated with the seat in which the user that removed a removable accessory 2 from the holding device 6 is seated.

Consequently, with reference to FIG. 1, if for example a user sitting in the passenger seat 3 and removes a removable accessory from a holding device associated with the passenger seat 3, the control unit 5 may be configured to determining a seating location of a user removing a removable accessory 2 from the holding device 6, and subsequently, based on the determined seating location, changing the setting of the vehicle compartment feature 7. In other words, the control unit 5 will determine that the user is seated in the passenger seat 3, and subsequently changing the setting of the vehicle compartment feature 7 associated with the seat of the user, i.e. the passenger seat 3. For example, the compartment lighting illuminating the passenger seat 3 may increase, and/or a vanity mirror function associated with the passenger seat 3 may be triggered, and/or the air temperature/flow exiting the air vents adjacent the passenger seat 3 may be adjusted, in response to removal of the removable accessory from the holding device of the passenger seat 3.

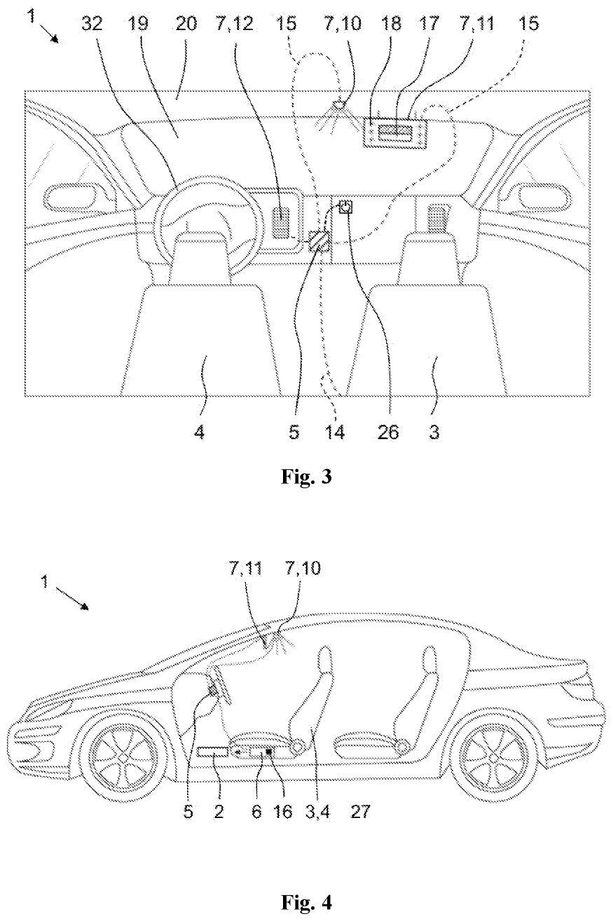

FIG. 3 and FIG. 4 each show similar example embodiments of the vehicle system according to the disclosure, but with small variations and in different views. Specifically, in the example embodiment of FIG. 3, the vehicle compartment features 7 are provided in form of a compartment light 10 that is illustrated as light source mounted in the interior roof 20 of the vehicle, and in form of a vanity mirror function 11 that is illustrated as a moveable vanity mirror 17 having integrated vanity mirror light 18 and being foldably mounted in the interior roof 20 of the vehicle, and additionally in form of a compartment climate system 12.

The example embodiment of the vehicle system shown in FIG. 3 further includes a user input control device 26 that is configured for enabling a user to manually, or by voice-control, change the setting of the vehicle compartment feature 7. Consequently, the control unit 5 may receive a user input signal from the user input control device 26 indicating that the user wishes a change in setting of the at least one vehicle compartment feature 7. In other words, if for example the vehicle compartment feature 7 is a vanity mirror 17, the vanity mirror 17 may be folded down to a display position, or up to a storage position, if the user actuates the user input control device 26.

In the example embodiment of FIG. 4, the vehicle compartment features 7 are provided in form of a compartment light 10 that is illustrated as light source mounted in the interior roof 20 of the vehicle, and in form of a vanity mirror function 11 that is illustrated as a moveable vanity mirror 17 that is foldably mounted in the interior roof 20 of the vehicle. The holding device 6 is illustrated as being integrated in a vehicle seat 3, 4, or being positioned under the seat 3, 4, and a sensor or detector device 16 associated with the holding device 6 is provided for generating a holding signal 14 that enables the control unit 5 to determine whether the holding device 6 is holding the removable accessory 2, or whether the holding device 6 is not holding the removable accessory 2.

FIG. 4 schematically illustrates a situation where the removable accessory 2 just has been removed from the holding device 6, and wherein the control unit 5 has controlled a vanity mirror 17 to fold down from a storage position to the display position, and activation of a compartment light 10.

FIG. 1 and FIG. 4 have illustrated the holding device 6 integrated in a vehicle seat 3, 4, or being positioned under the seat 3, 4. However, one or more holding device may be located at various locations within the vehicle for providing good access thereto for one or more users, independent of the user's seat of the vehicle.

In other words, one or more holding devices 6 may be provided adjacent the rear seats of the vehicle for enabling a user sitting in the rear sear access easy to the removable accessory, and automatic provision of vanity mirror function. In some example embodiments, the holding device may be arranged at a seat of the vehicle, or at an entrance door of the vehicle, or at a passenger leg space of the vehicle, or at a vehicle center console, or at a vehicle dashboard, or at a vehicle interior roof, or the like.

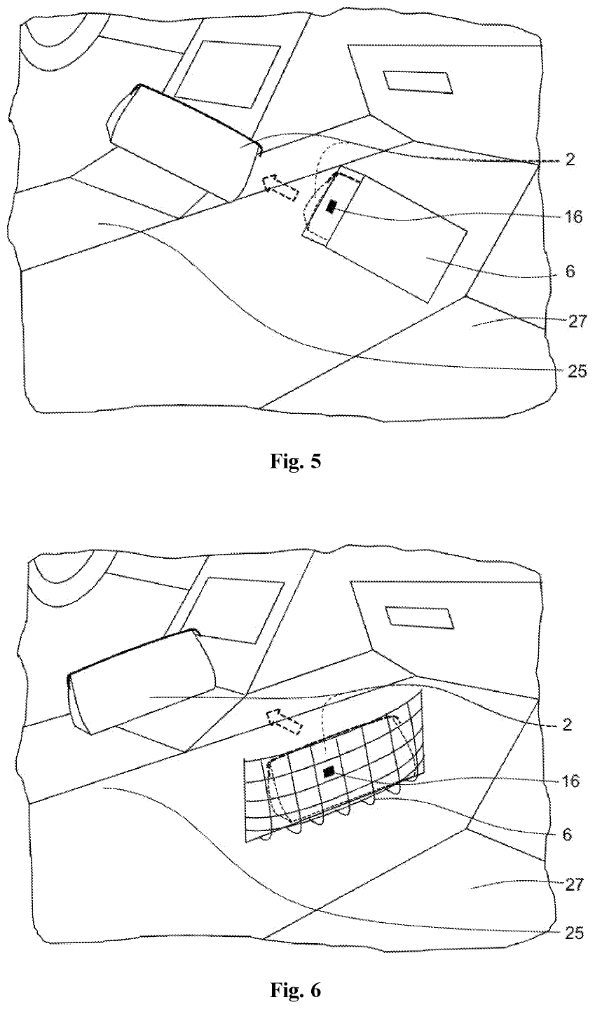

As an example, FIG. 5 shows the passenger leg space 27 of the vehicle and a holding device 6 fastened to a side surface of the vehicle center console 25. Moreover, the holding device 6 may comprise a non-closable container having a top opening for enabling easy removal and/or insertion of the removable accessory 2 from/into the holding device 6. A sensor or detector device 16 associated with the holding device 6 is provided for generating a holding signal 14 that enables the control unit 5 to determine whether the holding device 6 is holding the removable accessory 2, or whether the holding device 6 is not holding the removable accessory 2.

FIG. 6 shows schematically a further example embodiment of the passenger compartment holding device 6, which here is made from a net structure or wire structure suitable for holding the removable accessory 2. The net or wire structure may be made of a rigid net or wire structure, such that the holding device 6 is a non-closable container having a top or side opening for enabling easy removal and/or insertion of the removable accessory 2 from/into the holding device 6.

Alternatively, the net or wire structure may be made of an elastic net or wire structure, wherein the holding device 6 is normally in a closed state, in which the elastic net or wire structure is in a relatively non-tensioned state, and wherein the holding device 6 may be temporarily shifted to an open state by tensioning and elongating the net or wire structure at an opening region for opening the holding device 6 and enabling removal and/or insertion of the removable accessory 2 from/into the holding device 6.

The holding device 6 may be fastened to a side surface of the passenger leg space 27 of the vehicle. A sensor or detector device 16 associated with the holding device 6 is provided for generating a holding signal 14 that enables the control unit 5 to determine whether the holding device 6 is holding the removable accessory 2, or whether the holding device 6 is not holding the removable accessory 2.

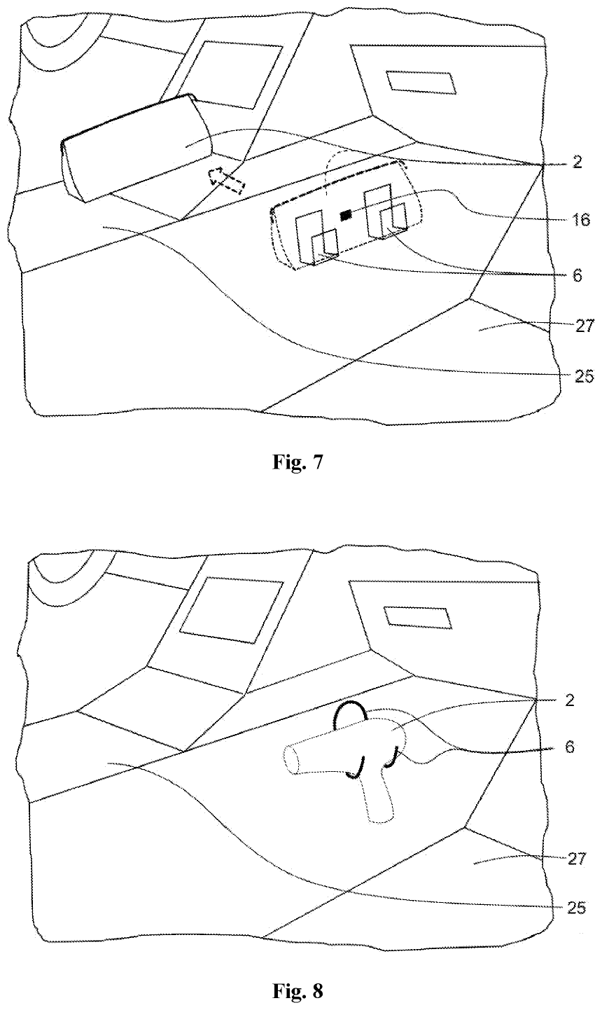

FIG. 7 shows schematically still a further example embodiment of the vehicle system, wherein the holding device 6 is fastened to a side surface of the vehicle center console 25 associated with the passenger leg space 27. The holding device 6 comprises two hook-shaped members that jointly are arranged to form a support surface suitable for holding the removable accessory 2, wherein the removable accessory 2 may be simple inserted or removed from holding device. A sensor or detector device 16 associated with the holding device 6 is provided for generating a holding signal 14 that enables the control unit 5 to determine whether the holding device 6 is holding the removable accessory 2, or whether the holding device 6 is not holding the removable accessory 2.

The removable accessory 2 may for example be a removable container including at least one vanity item. The container may be an openable and closable hard shell box, a soft shell bag, or the like. The vanity item stored within the container may for example be a make-up item, a make-up remover item, a hair dryer, a shaving item, a hair styling tool, a nail polish item or nail polish remover.

Alternatively, the removable accessory 2 may be a removable vanity item itself. An example embodiment of such a scenario is illustrated in FIG. 8, wherein the holding device 6 is fastened to a side surface of the vehicle center console 25 associated with the passenger leg space 27, and wherein the holding device 6 comprises a hook-shaped member that is arranged to hold a removable accessory 2 in form of a hair dryer. The hair dryer may be simple inserted or removed from holding device 6, and a sensor or detector device 16 associated with the holding device 6 is provided for generating a holding signal 14 that enables the control unit 5 to determine whether the holding device 6 is holding the removable accessory 2, or whether the holding device 6 is not holding the removable accessory 2.

In the example embodiments of FIGS. 1 and 4-8, the holding signal 14 is configured to indicate if the holding device 6 is holding the removable accessory 2 or not. However, in certain implementations, it may be difficult to correctly and reliably determining a holding status of the holding device 6, i.e. to determine whether the removable accessory 2 is located within the holding device 6, or not. In such case, it may sometimes be possible to instead monitoring the current setting of the holding device 6, which may be set in first and a second position.

For example, the holding device 6 may be an openable and closeable storage compartment, such as an openable and closeable glove-box, an openable and closeable dashboard storage compartment, or an openable and closeable storage drawer under the seat. Furthermore, the first position may correspond to a closed state of such storage compartment, and the second position may correspond to an open state, or at least a non-closed state, of said storage compartment.

Alternatively, the holding device 6 may be an openable and closeable clamping or gripping device that may be arranged to be opened for enabling removal of the removable accessory 2 from the holding device 6, and closed for enabling clamping or securement of the removable accessory 2 to the holding device 6. Furthermore, the first position may then correspond to a closed state of the holding device 6, and the second position may correspond to an open state, or at least a non-closed state, of the holding device 6. The clamping or gripping device may for example be switched from an open to a closed state by a manual actuation of a locking mechanism, such as a locking lever.

When monitoring the current setting of a holding device 6 that may be set in first and a second position, the control unit 5 may be configured to receive a holding signal 14 from the holding device 6, wherein the holding signal indicates if the holding device is in a first or second position. The control unit 5 is then configured to send a control signal 15 for changing a setting to the at least one vehicle compartment feature 7 in response to a change in the holding signal 14, wherein the vehicle compartment feature 7 is one of or any combination of compartment light 10, vanity mirror function 11, and compartment climate system 12.

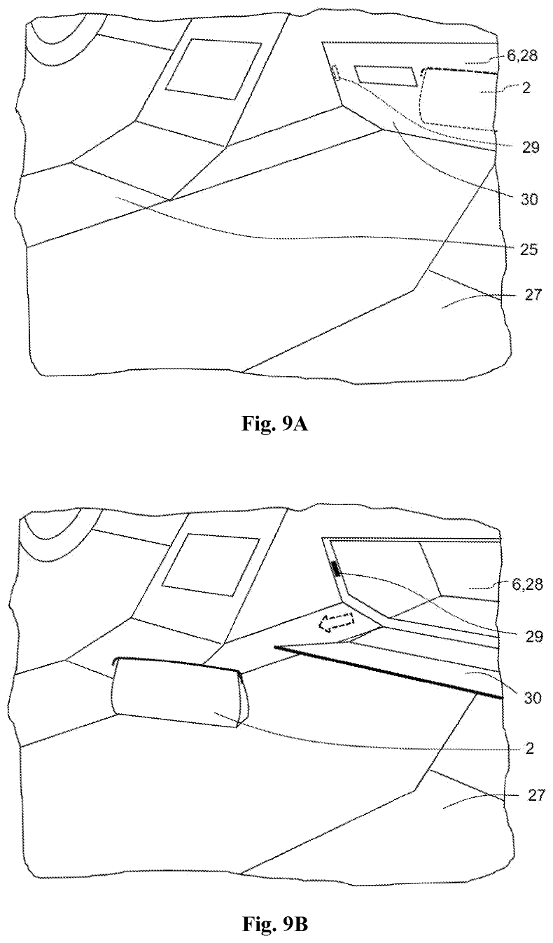

Such a scenario is schematically illustrated in FIGS. 9A and 9B, which shows a holding device in form of a glove-box 28 having an openable and closable lid 30. FIG. 9A shows the holding device 6, e.g. the glove-box 28, in a first position corresponding to the closed state of the lid 30, and with the removable accessory 2, such as a vanity bag, being stored within the glove-box 28. FIG. 9B shows the glove-box 28 in the second position corresponding to the opened state of the lid 30, and with the removable accessory 2 being removed from the glove-box 28.

Consequently, instead of monitoring and detecting the presence of the removable accessory 2 within the glove-box 28, some kind of sensor or detector device 29 associated with the holding device 6 generates a holding signal 14 that enables the control unit 5 to determine whether the holding device 6 is in the first or second position, e.g. whether the lid 30 is in an closed or opened state. In FIGS. 9A and 9B, the sensor or detector device 29 is arranged for detecting and distinguishing between a closed and opened lid 30, and may for example be arranged to detect the lid 30 when the lid 30 is located in the closed state.

Since the relative position of the glove-box 28 and lid 30 in the closed state is generally very well-defined, the sensor or detector device 29 may be designed and located to accurately and reliably detect for example the closed state of the glove-box 28. The same applies to all types of openable and closeable storage compartments and openable and closeable clamping or gripping device.

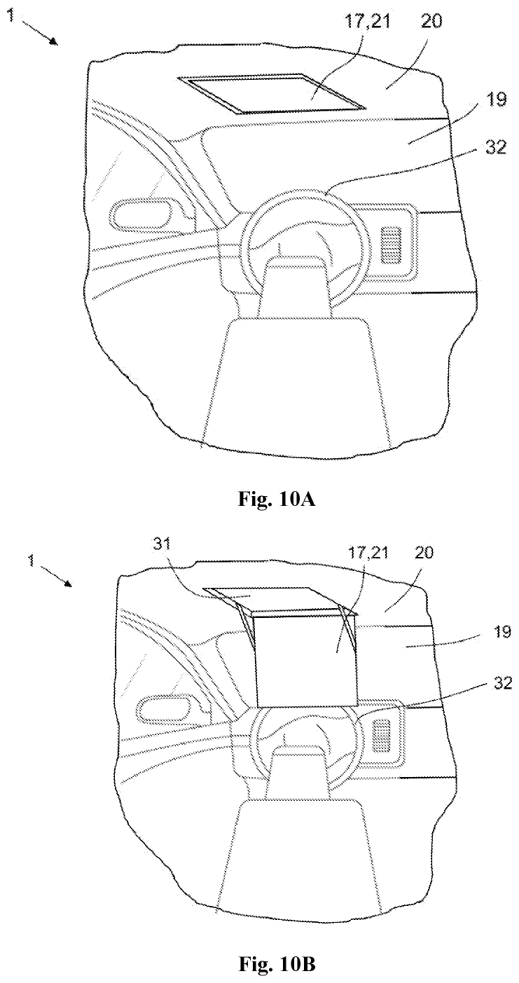

FIGS. 10A and 10B show part of an example embodiment of the vehicle system including a moveable vanity mirror 17 or electronic display 21 that may be set in a selfie mode for providing the function of a vanity mirror, similar to the example embodiments of FIGS. 1, 3 and 4, which also show a moveable vanity mirror 17 arranged in the interior roof 20 of the vehicle. In the example embodiment of FIGS. 10A-10B, the moveable vanity mirror 17 or electronic display 21 is arranged in the interior roof 20 in front of the driver, such that the moveable vanity mirror 17 or electronic display 21 may be moved between a storage position, as shown in FIG. 10A, and a display position, as shown in FIG. 10B.

The size and position of the moveable vanity mirror 17 or electronic display 21 in the display position may conceal and block the driver's view of the road ahead.

Therefore, the control unit 5 may be configured for obtaining a vehicle operating state and determining whether the current vehicle operating state is a safe state for moving the vanity mirror 17 or electronic display 21 from the storage position to the display position, and inhibiting any such movement of the moveable vanity mirror 17 or electronic display 21 when the current vehicle operating state is not in a safe state. A safe state may for example corresponds to a stationary vehicle or a vehicle operating in a self-driving mode.

When the vehicle is in a safe state, changing the setting to the at least one vehicle compartment feature in response to a change in the holding signal may involve moving a vanity mirror 17 or electronic display 21 that may be set in a selfie mode from a storage position to a display position, and wherein the vehicle comprises a recess 31 in the vehicle interior roof 20 for receiving the vanity mirror or electronic display 21 when being positioned in the storage position.

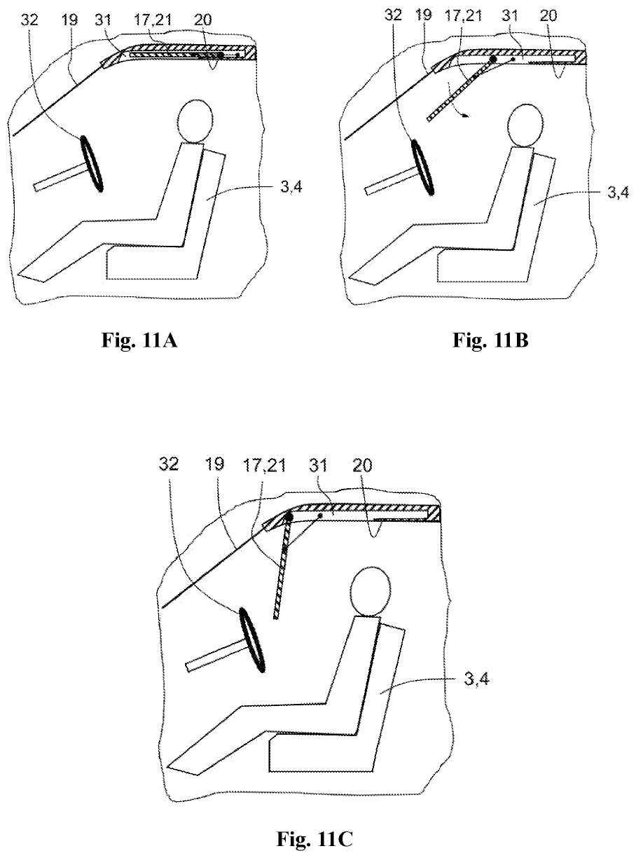

FIGS. 11A-11C show a sectional side-view of the moveable vanity mirror 17 or electronic display 21 that may be set in a selfie mode described with reference to FIGS. 10A-10B in a storage position, an intermediate position, and a display position, respectively. The motion mechanism controlling the motion of the moveable vanity mirror 17 or electronic display 21 may include an actuator, such as an electrical motor, and suitable linkage arms, guiding channels, and/or pivoting shafts, depending on the desired motion trajectory of the moveable vanity mirror 17 or electronic display 21.

Depending on size of the vanity mirror 17 or electronic display 21, other types of motion mechanisms may be used. Moreover, the vanity mirror may possibly be a flexible mirror or roll-up mirror, thereby enabling other types of motion mechanisms.

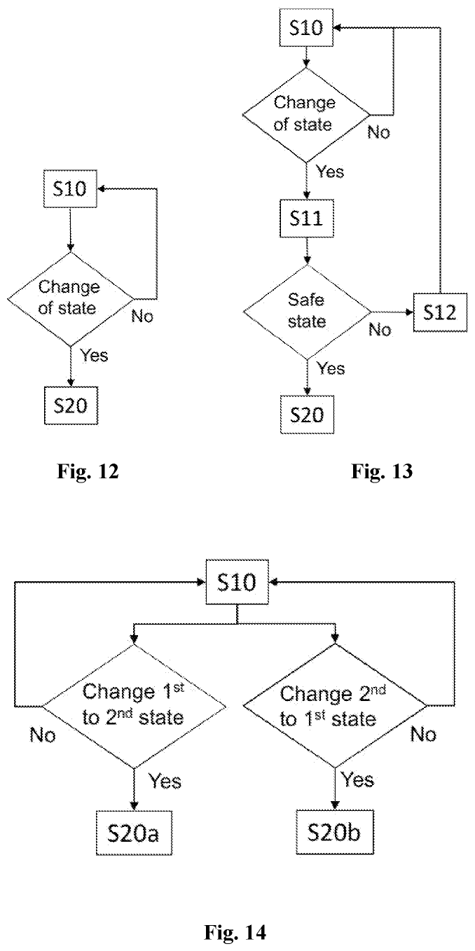

A first example embodiment of a computer-implemented method for simplifying use of a removable accessory 2 in a vehicle will be described below with reference to FIG. 12. The method comprises a first step S10 of monitoring, by means of a vehicle control unit 5, a state of a holding device 6 for holding the removable accessory 2.

A first state may correspond to when the holding device 6 is holding the removable accessory 2 and a second state may correspond to when the holding device 6 is not holding the removable accessory 2.

Alternatively, a first state may correspond to when the holding device is in a first position and a second state may correspond to when the holding device is in a second position

The method further comprises a second step S20 of changing, when the state changes, a setting to at least one vehicle compartment feature 7 by means of the vehicle control unit 5, wherein the at least one vehicle compartment feature 7 is one of or any combination of compartment light 10, vanity mirror function 11, and compartment climate system 12.

As described with reference to FIG. 13, the method may optionally include a first intermediate step S11 of obtaining information about the vehicle operating state by means of the vehicle control unit 5 and determining whether the current vehicle operating state is a safe state for changing the setting to the at least one vehicle compartment feature 7, or whether the current vehicle operating state is an unsafe state for changing the setting to the at least one vehicle compartment feature 7. The method may then include a subsequent intermediate step S12 of inhibiting any change of setting to the at least one vehicle compartment feature 7 unless the current vehicle operating state is the safe state.

The safe state may for example correspond to a stationary vehicle or a vehicle operating in a self-driving mode. Furthermore, detection and checking of safe state is primarily or only relevant when the vehicle driver removes the removable accessory from a holding device associated with the driver seat, because only the vehicle driver may need restrainment from distractive activity while driving.

Some example operation scenarios of the vehicle system will be described below with reference to FIG. 14, which shows the method described with reference to FIG. 12, but with more details relating to the type of change of state and the result.

The method comprises the first step S10 of monitoring, by means of a vehicle control unit 5, a state of a holding device 6 for holding the removable accessory 2, wherein the first state corresponds to when the holding device 6 is holding the removable accessory 2 and the second state corresponds to when the holding device 6 is not holding the removable accessory 2, or wherein the first state corresponds to when the holding device is in a first position and the second state corresponds to when the holding device is in a second position.

The method further comprises a second step S20a of increasing the intensity in compartment light 10 by means of the vehicle control unit 5 when the state of the holding device 6 goes from the first state to the second state, and a third step S20b of decreasing the intensity in compartment light 10 by means of the vehicle control unit 5 when the state of the holding device 6 goes from the second state to the first state.

Alternatively, on in combination with the method described above, the method may comprise a second step S20a of increasing an intensity in vanity mirror light 18 by means of the vehicle control unit 5 when the state of the holding device 6 goes from the first state to the second state, and a third step S20b of decreasing the intensity in vanity mirror light 18 by means of the vehicle control unit 5 when the state of the holding device 6 goes from the second state to the first state.

According to yet a further alternative embodiment, that may be combined with the methods described above, the method may comprise a second step S20a of initiating display of a vanity mirror 17, or initiating selfie mode of an electronic display 21, by means of the vehicle control unit 5 when the state of the holding device 6 goes from the first state to the second state, and a third step S20b of terminating display of the vanity mirror 17, or terminating the selfie mode of the electronic display 21, by means of the vehicle control unit 5 when the state of the holding device 6 goes from the second state to the first state.

The present disclosure has been presented above with reference to specific embodiments. However, other embodiments than the above described are possible and within the scope of the disclosure. For example, the vehicle system and associated method may be implemented in self-driving vehicles lacking a steering wheel. Different method steps than those described above, performing the method by hardware or software, may be provided within the scope of the disclosure. For example, the method described with reference to FIG. 14 may of course be altered to include also the first and second intermediate steps S11, S12 described with reference to FIG. 13.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof.

Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

What is claimed is:

1. A vehicle system comprising a control unit, a vehicle compartment holding device for holding a removable accessory, and at least one vehicle compartment feature, wherein
the control unit is configured to receive a holding signal from the holding device, the holding signal indicating:
if the holding device is holding the removable accessory or not, or
if the holding device is in a first or second position, and
the control unit is further configured to send a control signal for changing a setting to the at least one vehicle compartment feature in response to a change in the holding signal,
wherein the vehicle compartment feature is one of or any combination of compartment light, vanity mirror function, and compartment climate system.

2. The vehicle system according to claim 1, further comprising a removable accessory in form of a removable container including at least one vanity item, or in form of a removable vanity item.

3. The vehicle system according to claim 2, wherein the vanity item is a make-up item, a make-up remover item, a hair dryer, a shaving item, a hair styling tool, a nail polish item or nail polish remover.

4. The vehicle system according to claim 1, wherein the holding device is an openable and closeable storage compartment or an openable and closeable clamping device.

5. The vehicle system according to claim 1, wherein the compartment climate system includes at least one air vent configured for enabling ventilation air of the climate system to enter the passenger compartment, wherein the air vent is located in a vehicle dashboard, a vehicle A-pillar and/or a vehicle B-pillar.

6. The vehicle system according to claim 1, wherein the compartment climate system includes at least one air vent configured for enabling ventilation air of the climate system to enter the passenger compartment, wherein the air vent is adjustable in terms of flow direction and/or flow opening area for enabling the occupant to adjust direction and flow rate of incoming ventilation air the ventilation.

7. The vehicle system according to claim 1, wherein the control unit is configured for monitoring a state of the holding device,
wherein a first state corresponds to when the holding device is holding the removable accessory and a second state corresponds to when the holding device is not holding the removable accessory, or
wherein a first state corresponds to when the holding device is in a closed state and a second state corresponds to when the holding device is in an open state, and wherein the control unit is configured to increase the intensity in compartment light when the state of the holding device goes from the first state to the second state, and to decrease the intensity in compartment light when the state of the holding device goes from the second state to the first state.

8. A vehicle comprising the system according to claim 1.

9. The vehicle according to claim 8, wherein the holding device is arranged at a seat of the vehicle, at an entrance door of the vehicle, at a passenger leg space of the vehicle, at a vehicle center console, at a vehicle dashboard, or at a vehicle interior roof.

10. The vehicle according to claim 8, wherein changing the setting to the at least one vehicle compartment feature in response to a change in the holding signal involves moving a vanity mirror or electronic display that may be set in a selfie mode from a storage position to a display position, and wherein the vehicle comprises a recess in the roof for receiving the vanity mirror or electronic display when being positioned in the storage position.

11. The vehicle according to claim 8, wherein the vehicle comprises a plurality of seats for vehicle passengers, and wherein the control unit is configured to:
determining a seating location of a user removing a removable accessory from the holding device, and
based on the determined seating location, changing the setting of the vehicle compartment feature.

12. A computer-implemented method for simplifying use of a removable accessory in a vehicle, the method comprising:
monitoring, by means of a vehicle control unit, a state of a holding device for holding the removable accessory,
wherein a first state corresponds to when the holding device is holding the removable accessory and a second state corresponds to when the holding device is not holding the removable accessory, or
wherein a first state corresponds to when the holding device is in a first position and a second state corresponds to when the holding device is in a second position, and
when the state changes, changing a setting to at least one vehicle compartment feature by means of the vehicle control unit, wherein the at least one vehicle compartment feature is one of or any combination of compartment light, vanity mirror function, and compartment climate system.

13. The method according to claim 12, wherein the removable accessory is a removable container with at least one vanity item, or a removable vanity item.

14. The method according to claim 12, wherein changing the setting to the at least one vehicle compartment feature involves:
increasing the intensity in compartment light by means of the vehicle control unit when the state of the holding device goes from the first state to the second state, and
decreasing the intensity in compartment light by means of the vehicle control unit when the state of the holding device goes from the second state to the first state.

15. The method according to claim 12, wherein changing the setting to at least one vehicle compartment feature involves:
increasing an intensity in vanity mirror light by means of the vehicle control unit when the state of the holding device goes from the first state to the second state, and
decreasing the intensity in vanity mirror light by means of the vehicle control unit when the state of the holding device goes from the second state to the first state.

16. The method according to claim 12, wherein changing the setting to at least one vehicle compartment feature involves:
initiating display of a vanity mirror, or initiating selfie mode of an electronic display, by means of the vehicle control unit when the state of the holding device goes from the first state to the second state, and
terminating display of the vanity mirror, or terminating the selfie mode of the electronic display, by means of the vehicle control unit when the state of the holding device goes from the second state to the first state.

17. The method according to claim 12, further comprising:
obtaining a vehicle operating state by means of the vehicle control unit and determining whether the current vehicle operating state is a safe state for changing the setting to the at least one vehicle compartment feature, or whether the current vehicle operating state is an unsafe state for changing the setting to the at least one vehicle compartment feature, and
inhibiting any change of setting to the at least one vehicle compartment feature unless the current vehicle operating state is the safe state.

18. The method according to claim 17, wherein a safe state corresponds to a stationary vehicle or a vehicle operating in a self-driving mode.
